(19) United States
(12) Patent Application Publication
(10) Pub. No.: US 2026/0009995 A1
(43) Pub. Date: Jan. 8, 2026

(54) LEVELLING SYSTEM FOR SINGLE MOLECULE IMAGING

(71) Applicant: SMI Drug Discovery Limited, Cambridge (GB)

(72) Inventors: Andrew James Thompson, Cambridge (GB); James Alan Brozik, Pullman, WA (US); Michael Joe Martinez, Pullman, WA (US); Evan Lewis Taylor, Pullman, WA (US); Mark Peter Rogers, Cambridge (GB); Matthew Read, Cambridge (GB)

(21) Appl. No.: 19/156,393

(22) PCT Filed: Feb. 14, 2024
(86) PCT No.: PCT/GB2024/050392

§ 371 Date: Sep. 16, 2025

(30) Foreign Application Priority Data
Feb. 14, 2023 (GB) 2302060.5

(51) Int. Cl. G02B 21/26

(52) U.S. Cl. CPC G02B 21/26

(57) ABSTRACT

A nanometre scale levelling system (10) for a sample surface (20) for imaging samples comprising single molecules is disclosed. The system (10) comprises a sample surface (20) configured to hold samples comprising single molecules for imaging. The system (10) further comprises a leveller with nanometre resolution configured to adjust a level of the sample surface (20) relative to a reference plane. The leveller is configured to adjust a level of a first (40), second (50) and third (60) point on the sample surface until they are each level with the reference plane on a nanometre scale.

### FIELD OF INVENTION

The present invention relates to a levelling system and method for levelling a single molecule imaging sample surface with nanometre resolution.

### BACKGROUND OF THE INVENTION

Optical microscopy is a microscopy technique that uses light to produce an image and can be used to image single molecules. An optical microscope for single molecule imaging is disclosed in international patent application with publication No. WO 2020/245579 with the same applicant as the present patent application. Single molecule imaging can be defined as the visualisation of individual molecules with a resolution measured in nanometres. Broadly, the optical microscope of international patent application with publication No. WO 2020/245579 comprises, in a single housing, a first optical microscope in the form of a confocal microscope, and a second optical microscope in the form of a total internal reflection fluorescence microscope. Significantly, to provide this very high resolution, the second optical microscope is used to correct drift from the first optical microscope.

Single molecules can range in size from on the order of picometres to nanometres, a nanometre being one-billionth of a meter. By comparison, a human hair has a diameter of 80,000 to 100,000 nanometres; a single gold atom is about a third of a nanometre in diameter; a single water molecule is about 1.5 nanometres; and a strand of human DNA is 2.5 nanometres in diameter. When samples comprising single molecules are observed, using a microscope or other imaging device, it is critical that the sample is maintained within a narrow depth of field. The larger the field of view or area over which the sample is distributed, the more challenging it becomes to maintain a coincident sample plane relative to the focal plane of a microscope. Even small changes, on the order of nanometres, in the tilt of the sample surface on which the sample is held, relative to the focal plane, will place single molecules outside of diffraction limited focus. This is especially true when imaging fluorescence from single molecules.

In known microscopic imaging, sample surfaces are aligned with the focal plane of a microscope by adjusting the position of the surface or microscope objective in the z-direction. When a new area is selected for viewing, objects outside of the original area of interest are often above or below the focal plane, and a new focus must be reached. For single molecules, this is particularly important as the depth of the focal plane is extremely small and the time needed to find the new focus can result in significant bleaching of the fluorescent molecules by the excitation source.

### SUMMARY OF THE INVENTION

The invention is defined by the independent claims to which reference should now be made. Optional features are defined by the dependent claims.

An example arrangement is described in more detail below and takes the form of a nanometre scale levelling system for a sample surface for imaging samples comprising single molecules. The system comprises a sample surface configured to hold samples comprising single molecules for imaging. The system further comprises a leveller with nanometre resolution configured to adjust a level of the sample surface relative to a reference plane. The leveller is configured to adjust a level of a first, second and third point on the sample surface until they are each level with the reference plane on a nanometre scale.

The inventors have appreciated that known methods for aligning a sample surface with the focal plane of a microscope, or other imaging means, are not sufficient in the context of single molecule imaging. In particular, the inventors have appreciated that even small changes, on the order of nanometres, in the tilt of the sample surface on which the sample is held, relative to the focal plane, will place single molecules outside of diffraction limited focus. The present invention acknowledges and aims to address this problem.

According to one aspect of the present invention there is provided a nanometre scale levelling system for a sample surface for imaging samples comprising single molecules, the system comprising: a sample surface configured to hold samples comprising single molecules for imaging; and a leveller with nanometre resolution configured to adjust a level of the sample surface relative to a reference plane; wherein the leveller is configured to adjust a level of a first, second and third point on the sample surface until the first, second and third point are each level with the reference plane on a nanometre scale.

In one example, the leveller is further configured to adjust the level of the first and second points to provide pitch and roll adjustments to the sample surface relative to the reference plane.

In one example, the leveller is further configured to simultaneously adjust the level of the first, second and third points until they are each level with the reference plane on a nanometre scale.

In one example, each of the first, second and third points on the sample surface comprise a marker configured to provide a reference point for the leveller.

In one example, the marker is a fiducial marker.

In one example, the leveller further comprises a plate, wherein the sample surface forms a first surface of the plate.

In one example, the plate comprises a second surface opposing the sample surface.

In one example, the second surface comprises a first, second and third point respectively corresponding to the first, second, and third points on the sample surface.

In one example, the leveller comprises a first, second, and third kinematic mount respectively coupled to the first, second and third points on the second surface of the plate.

In one example, the leveller further comprises a first, second and third actuator respectively coupled to the first, second and third kinematic mounts.

In one example, each actuator is configured to adjust the level of a point on the sample surface via the kinematic mount to which it is coupled.

In one example, the plate is a sample vessel.

In one example, the leveller is configured to adjust the level of the first, second and third points on the levelling surface in a first and second direction.

In one example, the first and second directions oppose one another, extending from the sample surface.

In one example, the first, second and third points are closer to a periphery of the surface than a central point of the surface.

In one example, the leveller is configured to adjust the level of the first, second and third points in increments between 10 and 80 nanometres.

In one example, the system further comprises an imaging means.

In one example, the reference plane is a focal plane of the imaging means.

In one example, the imaging means is a microscope having a resolution of less than 10 micrometres in its z direction.

In one example, the imaging means is configured to image single molecules.

In one example, the leveller is configured to adjust the level of the first, second and third points sequentially.

According to another aspect of the present invention there is provided a nanometre scale levelling method for a sample surface for imaging samples comprising single molecules on a nanometre scale, the method comprising: adjusting a level of a first, second and third point on a sample surface relative to a reference plane, the sample surface being configured to hold samples comprising single molecules for imaging, until the first, second and third points are level with the reference plane on a nanometre scale.

According to another aspect of the present invention there is provided a computer program product which when executed implements the nanometre scale levelling method.

According to another aspect of the present invention there is provided a non-transitory computer readable medium on which are encoded instructions for carrying out the nanometre scale levelling method.

According to another aspect of the present invention there is provided a computer-readable medium on which are encoded instructions for carrying out the nanometre scale levelling method.

The computer readable medium or non-transitory computer readable medium may be, for example, solid state memory, a hard disk drive, a USB memory stick, a CD-ROM or a DVD-ROM.

### BRIEF DESCRIPTION OF DRAWINGS

The invention will be described in more detail by way of examples with reference to the accompanying drawings, in which:

FIG. 1 is a schematic diagram showing a system for adjusting the level of a sample surface according to aspects of the present disclosure;

FIG. 2 is a schematic diagram showing a side view of the system of FIG. 1;

FIG. 3 is a schematic diagram showing a part cross-sectional view of the system of FIGS. 1 and 2;

FIG. 4 is a schematic diagram showing a plan view of a sample surface according to aspects of the present disclosure;

FIG. 5 is a schematic diagram of a leveller according to aspects of the present disclosure;

FIG. 6 is a schematic diagram of a sample surface that is out of alignment with the focal plane of a microscope according to aspects of the present disclosure;

FIG. 7 is a schematic diagram showing the sample surface of FIG. 6 after having been levelled with the focal plane according to aspects of the present disclosure; and

FIG. 8 is a series of images comparing, at different z-axis deviations from the focal plane, a non-levelled imaged surface and a levelled imaged surface according to aspects of the present disclosure.

### DETAILED DESCRIPTION

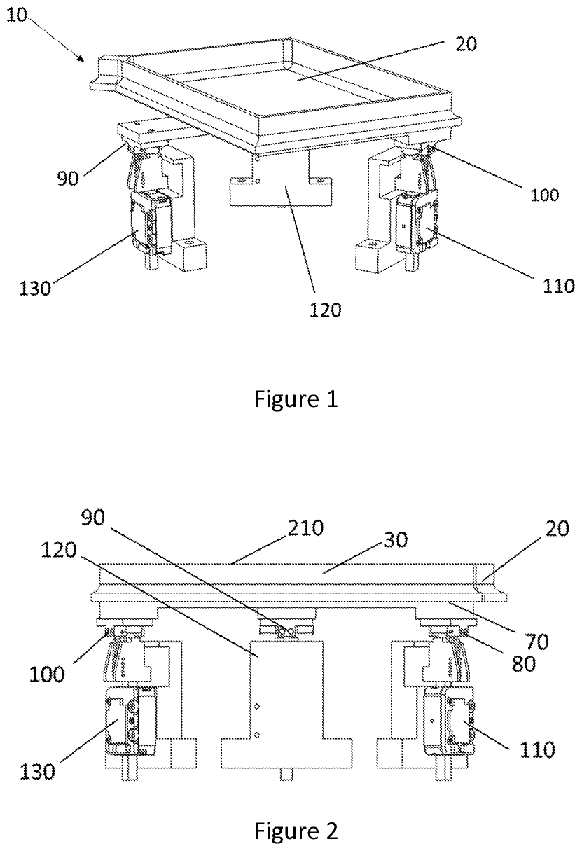

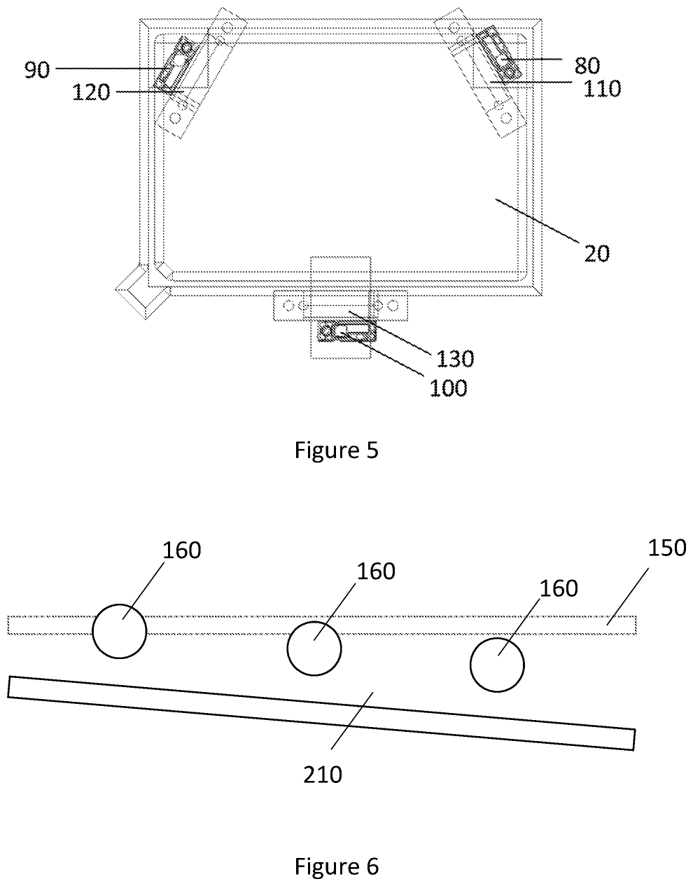

An example system 10 for adjusting a level of a molecular imaging sample surface with nanometre resolution according to aspects of the present disclosure is shown in FIGS. 1 to 7. The system 10 is for operation with an optical microscope for single molecule imaging (not shown) such as that disclosed in international patent application with publication No. WO 2020/245579 described above and incorporated herein by reference. The optical microscope of international patent application with publication No. WO 2020/245579 comprises, in a single housing, a first optical microscope in the form of a confocal microscope, and a second optical microscope in the form of a total internal reflection fluorescence microscope. Significantly, the second optical microscope is used to correct drift from the first optical microscope. Such an optical system can achieve an imaging resolution of less than 10 micrometres in its z-direction. More specifically, up to 180 nm in the z-direction. However, the system 10 is also suitable for use with other imaging means. For example, a single confocal microscope.

Referring to FIGS. 1 to 5, the system comprises a sample surface 210. The sample surface 210 is configured to hold, or retain, samples comprising single molecules. In this example, the sample surface 210 forms part of an assay plate 30 which is placed into the assay plate holder 20. Specifically, in this example the surface 210 forms part of a 96-well assay plate. However, in other examples the surface 20 could form part of any surface configured to hold samples comprising single molecules. Examples include, but are not limited to, a glass microscope slide, a glass surface etched with microfluidic channels, a metal plate, an engraved glass surface, or a glass coverslip. Surface 210 could also, in other examples, form part of an assay plate with a different number of wells. For example, 6, 24, 384 or 1536-well assay plates. The system 10 further comprises a leveller. The leveller is configured to adjust the level of three known, or pre-determined, points 40, 50, 60 on the sample surface 210, as shown in the plan view of FIG. 4. In this example, the first 40, second 50 and third 60 points are marked. In other words, each of the first, second, and third points comprises a marker. In this example, the markers are fiducial markers. A fiducial marker is defined as a uniquely identifiable fluorescent point. The fiducial markers are, for example, one of, or a combination of, laser etched markers or printed markers. As explained in more detail below, they are used as reference points for levelling the sample surface 210. Referring still to FIGS. 1 to 5, the sample surface 210 forms a first surface of a plate 30. As explained above, in this example the plate 30 is an assay plate. The system 10 further comprises a second surface 70. In this example, the second surface forms part of the base of the assay plate holder 20. Said second surface 70 opposes the sample surface 210. If the sample surface 210 is considered as forming the ‘top’ surface of the plate 30 that is imaged by the optical microscope for single molecule imaging, the second surface 70 can be considered as forming the ‘bottom’ surface of the plate holder 20. Each point 40, 50, 60 on the sample surface 210 has a corresponding, or opposing, point on the second surface 70. In this example, first, second and third points (not shown) on the second surface 70 respectively oppose the first 40, second 50 and third 60 points on the sample surface 210. Each point 40, 50, 60 on the sample surface 210 and its corresponding point on the second surface form a pair. In this example, the fiducial markers are positioned on the ‘top’ surface 210. In other words, they mark the points on the sample surface 210. The microscope objective views these fiducial markers from above for the levelling process described in more detail below. However, in other examples, the fiducial markers could be on the ‘bottom’ surface 70. In other words, they mark the points on the second surface 70. The microscope objective would, in such an example, be positioned to view the fiducials from ‘below’ for the levelling process.

Still referring to FIGS. 1 to 5, in this example, the leveller comprises kinematic mounts 80, 90, 100. A kinematic mount is coupled to each of the points on the second surface 70. Therefore, in this example, there are three and only three kinematic mounts 80, 90, 100. The kinematic mounts 80, 90, 100 restrict the leveller to adjusting the position of the points 40, 50, 60 on the sample surface 210 in two directions. In other words, the leveller is configured to adjust the level of points 40, 50, 60 on the sample surface 210 in a first direction and second direction. The first and second directions oppose one another, extending from the sample surface 210. Adjusting in the first direction can be described as elevation. Adjusting in the second direction can be thought of as depression. If the focal plane of the microscope is considered as existing in the x-y plane, the first and second directions form the z-axis.

The leveller further comprises actuators 110, 120, 130. An actuator is coupled to each of the kinematic mounts 80, 90, 100. Therefore, in this example, there are three and only three actuators 110, 120, 130. In this way, each actuator 110, 120, 130 is configured to adjust the level of a point 40, 50, 60 on the sample surface 20 by elevating or depressing via a kinematic mount 80, 90, 100 at its corresponding point on the second surface 70, the plate 30. The actuators 110, 120, 130 are high precision actuators. In this example, each actuator 110, 120, 130 has nanometre resolution. The leveller is, therefore, configured to adjust the level of points 40, 50, 60 on the sample surface 210 in increments on the order of nanometres. Specifically, in this example, the actuators 110, 120, 130 are configured to adjust the level of points 40, 50, 60 on the sample surface 210 in increments between 10 and 80 nanometres.

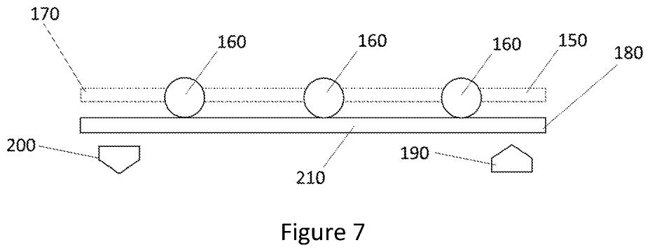

The above-described system 10 is configured to level the sample surface 210 in the context of imaging samples comprising single molecules. FIG. 6 shows an example sample surface 210 which is not level, or not aligned, with the focal plane 150 of a microscope (not shown). There are three samples 160 on the surface 210. The sample surface 210 is tilted out of alignment with the focal plane 150 of the microscope such that some of the samples 160 are not coincident with the focal plane 150 of the microscope. Some of the samples 160 are, therefore, out of focus. FIG. 7 then shows the same sample surface 210 having been levelled, or aligned, with the focal plane 150. In this example, levelling refers to positioning the sample surface 210 such that all the single molecule samples 160 are coincident with the focal plane 150 of the microscope. In comparison with FIG. 6, in FIG. 7 the tilt has been corrected. In the example shown, the left-most end 170 of the surface 210 has been depressed relative to the right-most end 180. The right-most end 180 of the surface 210 has been elevated. The directions of elevation 190 and depression 200 are indicated. Levelling of the sample surface 210 has been achieved by focusing on a known location upon the surface 210 and locking that location to the location of the focal plane 150 to the microscope. The same is repeated for additional known locations upon the same surface 210. Specifically, in this example, the focal plane of a first known location 40 is established and locked to the focal plane. The procedure is repeated at a second known location 50 and then a third known location 60. The way in which this is carried out is significant and is discussed in more detail below. It is worth noting that FIGS. 6 and 7 are inverted if the single molecules 160 (printed on the surface to be imaged) are attached to the surface of an inverted plate. They would, therefore, be below surface 210. However, this does not change the levelling concept according to aspects of the present disclosure.

Referring to the plan view of FIG. 4, the leveller is used to level the sample surface 210 with the focal plane 150 of the microscope. As explained above, even misalignment on the scale of nanometres will place the single molecule samples 160 out of diffraction limited focus. The leveller, therefore, is configured to adjust the level of the sample surface 210 in increments on the order of nanometres. The leveller is configured to adjust the level of a first point 40 on the sample surface 210. The leveller is then configured to adjust the level of a second point 50 on the surface 210. The leveller is then further configured to adjust the level of a third point 60 on the surface 210. In this example, levelling of the first 40 and second 50 points provide pitch and roll adjustments to flatten out the sample surface 210. Pitch and roll adjustments are adjustments about the x and y axes. Such adjustments are carried out to make the sample surface 210 parallel to the focal plane of the imaging means. Such adjustments are carried out to focus in the z axis. All three points are, therefore, used for focus in the z-axis. This provides the advantage of a continuous focal plane of the sample over the entirety of the sample surface 210.

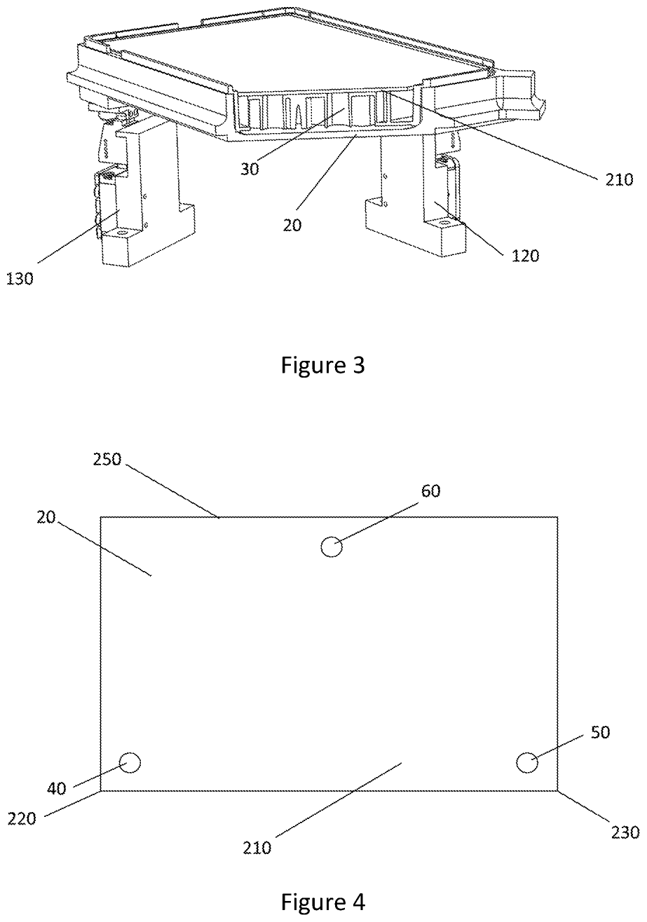

To level the surface 210, the leveller adjusts the level of each point 40, 50, 60 until they are level, or coincide, with a chosen reference plane on a nanometre scale. In this example, a nanometre scale is defined as a scale on the order of nanometres. Specifically, relating to structures with a length scale between 1 and 999 nanometres. In this example, the reference plane is the focal plane 150 of the microscope. The focal plane of the microscope in the example system of FIGS. 1 to 5 is indicated in FIG. 3. The sample surface 210 is level with the focal plane in this Figure. In this example, levelling is performed sequentially. In other words, the level of the first point 40 is adjusted until it is level with the focal plane 150. Then, the level of the second point 50 is adjusted until it is level with the focal plane 150. Finally, the level of the third point 60 is adjusted until it is level with the focal plane 150. Following completion of these focusing procedures, if all points are moved equally in the same direction, the sample surface 210 will move parallel to the focal plane 150 in the z direction. This ensures that the sample surface remains parallel with the focal plane of the microscope due to the previously made pitch and roll adjustments to the first 40, second 50 and third 60 points.

Although the levelling of each point 40, 50, 60 is performed sequentially, it does not matter in which order levelling is completed; the points can be levelled in any order. In another example, the level of the second point 50 is adjusted before the level of the third point 60 and then that of the first point 40. In yet another example, the level of the third point 60 is adjusted before the level of the first point 40 and then that of the second point 50. In the example described above with reference to FIGS. 1 to 7, the system relies on the use of the fiducial markers to level the surface 210 and, therefore, achieve focus at each of the points 40, 50, 60 on the sample surface 210. As explained above, each point 40, 50, 60 comprises a fiducial marker which is used to identify the points on the sample surface 210. The fiducial markers further provide a reference for the levelling process. The level of each point 40, 50, 60 is adjusted, as previously described, such that its fiducial marker is in the focal plane of the imaging means. As a result, each of the corresponding points on the sample surface 210 are in the focal plane of the imaging means. In summary, microscope focusing is used to establish a level at three separate locations on surface 210.

The use of three and only three points is significant. This is because a plane is uniquely determined by any of the following: three non-collinear points; a line and a point, the point not being on said line; two distinct but intersecting lines; or two distinct but parallel lines. Three-point levelling is, therefore, ideal for adjusting a tilted plane. Using the three pre-determined points as coordinates on a plane defined by the sample surface, the tilt relative to the imaging system can be accommodated and corrected for. Specifically, the tilt relative to the focal plane of the imaging means. By levelling the sample surface 210 in this way, the sample surface 210 can be levelled such that it is, on a nanometre scale, flat and coinciding with the focal plane of the microscope. All locations on the plane defined by the sample surface 210 will, therefore, be perpendicular to the optics of the imaging system and in focus. As a result, all samples at all locations on the sample surface 210 will be in focus for subsequent imaging. The use of three and only three points further enables a time efficient means of levelling a sample surface for imaging.

The points 40, 50, 60 on the surface 210 are offset from one another. The inventors have found that it is optimal in terms of resolution to have the points widely distributed on the surface 210. This ensures levelling of the surface 210 over a large distance. In this example, this has been achieved by choosing points 40, 50, 60 that are closer to a periphery of the surface 210 than a central point of the surface 210. More specifically, the first 40, second 50, and third 60 points are each positioned such that they form the vertices of a triangular shape. In this example, the third point 60 is positioned adjacent to the midpoint of an edge 250 of the surface 210 (FIG. 4). Said edge 250 opposes first and second corners 220, 230 of the surface 210. The first point 40 is positioned adjacent to said first corner 220. The second point 50 is positioned adjacent to said second corner 230. As the sample surface 210 in this example has a rectangular cross section, this formation maximises the distance between the points 40, 50, 60 on the surface 210. To summarise, levelling at three locations establishes a level over a large area. Levelling at points 40, 50 and 60 establishes a level throughout plane 210 with nanometre precision. Specifically, in this example, levelling at points 40, 50 and 60 leave the sample surface parallel to the focal plane of the microscope to less than a micron in pitch and roll over the sample surface. In this example, the sample surface is 11 centimetres by 7.5 centimetres in size. This gives a diagonal of 13 centimetres. However, in other examples, the sample surface could be larger.

The method of levelling the sample surface 210 is automated. To automate the system 10, a computer program or a computer program stored on a computer program product is configured to implement the method when executed, or a computer-readable medium, or non-transitory computer readable medium, on which are encoded instructions is provided for carrying out the method. In this example, the system 10 further comprises a computer or processing means configured to execute said computer program. In this way, the levelling process does not require intervention between levelling each point 40, 50, 60 on the sample surface 210. As explained above, the sample plane 210 is altered using high-precision actuators 110, 120, 130 with nanometre resolution located beneath each of the known locations 40, 50, 60. In this example, the resolution of the actuators 110, 120, 130 defines the resolution of the means for levelling the sample surface. Specifically, in this example, the actuators have a resolution between 10 and 80 nanometres. When the first actuator 110 below the first known location 40 has completed its levelling routine, the process can proceed to the second actuator 120 at the second known location 50. Then, once the second actuator 120 below the second known location 50 has completed its levelling routine, the process can proceed to the third actuator 130 below the third known location 60. In this example, this cycle is continued until the sample plane 210 is coincident with the focal plane 150 of the microscope at all three known locations on the surface 210.

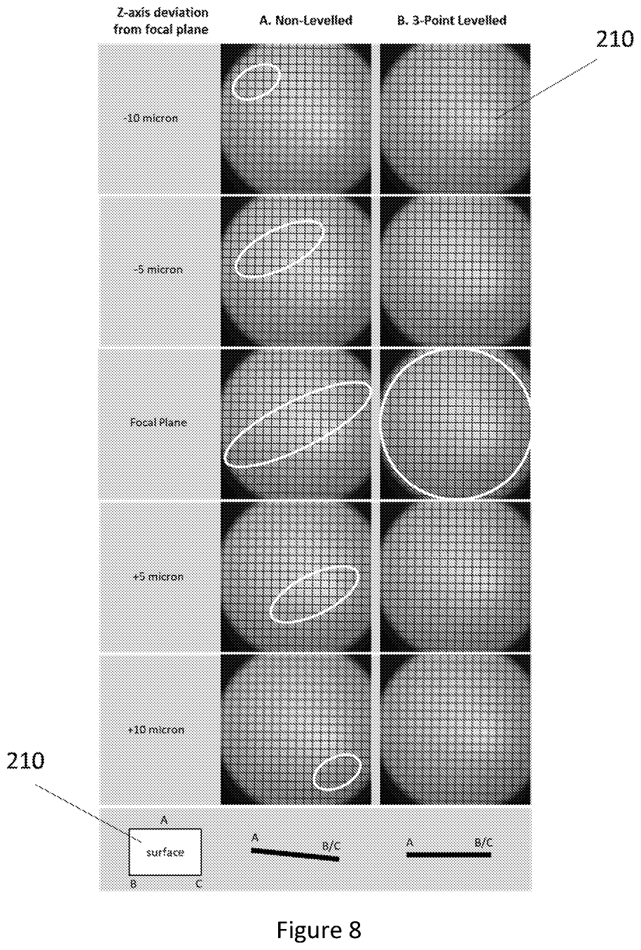

A series of images comparing an example non-levelled sample surface (A) and an example 3-point levelled sample surface according to aspects of the present disclosure is shown in FIG. 8. In this example, the sample surface 210 is an imaged surface. A square grid is overlaid on the imaged surface 210 for focusing purposes. Each square of the grid is 50 microns by 50 microns (50 μm×50 μm). An oval or circle is overlaid over the area of each imaged surface 210 that is in focus. The left-hand side (A) of FIG. 8 shows a non-levelled surface as it is traversed from below the focal plane to above the focal plane in 5 μm increments. As is seen in the series of images, the focus area increases until 0 μm, at which the focus area is the largest. The focus area then decreases as the slide is moved further from the focal plane. The right-hand side (B) of FIG. 8 shows a 3-point levelled slide 210 traversed in the same manner as the slide of the left hand side (A). The whole field of view is out of focus until the focal plane is reached at Oum. At Oum, the entire field of view is within focus. FIG. 8 demonstrates that the 3-point levelling system described herein enables viewing single molecules uniformly across the sample surface 210 without further adjustment to the surface in the z-axis.

By automating levelling with nanometre resolution to level known locations on a sample surface, the above-described system and method provides high-resolution, automated levelling of a surface relative to a fixed focal plane. Furthermore, by focusing onto points that are distributed at known locations that are widely distributed along the surface, the system and method provide levelling over a large distance. The system and method facilitate maintaining a level across a planar surface such that the whole surface can be imaged within the same depth of field without refocusing. This leads to improved imaging of single molecules at the nanometre scale without the need to refocus which is time consuming and can lead to photobleaching in the area of interest. As the levelling of the sample surface according to aspects of the present disclosure is undertaken prior to subsequent imaging of samples, the system and method provide a mechanism that allows single particle imaging without repeated autofocus during image acquisition.

Embodiments of the present invention have been described with particular reference to the examples illustrated. However, it will be appreciated that variations and modifications may be made to the examples described within the scope of the present invention.

1. A nanometre scale levelling system for a sample surface for imaging samples comprising single molecules, the system comprising:
a sample surface configured to hold samples comprising single molecules for imaging; and
a leveller with nanometre resolution configured to adjust a level of the sample surface relative to a reference plane;
wherein the leveller is configured to adjust a level of a first, second and third point on the sample surface until the first, second and third point are each level with the reference plane on a nanometre scale.

2. The system of claim 1 wherein the leveller is further configured to adjust the level of the first and second points to provide pitch and roll adjustments to the sample surface relative to the reference plane.

3. The system of claim 1 or claim 2 wherein the leveller is further configured to simultaneously adjust the level of the first, second and third points until they are each level with the reference plane on a nanometre scale.

4. The system of any preceding claim wherein each of the first, second and third points on the sample surface comprise a marker configured to provide a reference point for the leveller.

5. The system of claim 4 wherein the marker is a fiducial marker.

6. The system of any preceding claim further comprising a plate, wherein the sample surface forms a first surface of the plate.

7. The system of any preceding claim further comprising a second surface opposing the sample surface.

8. The system of claim 7 wherein the second surface comprises a first, second and third point respectively corresponding to the first, second, and third points on the sample surface.

9. The system of claim 8 wherein the leveller comprises a first, second, and third kinematic mount respectively coupled to the first, second and third points on the second surface of the plate.

10. The system of claim 9 wherein the leveller further comprises a first, second and third actuator respectively coupled to the first, second and third kinematic mounts.

11. The system of claim 10 wherein each actuator is configured to adjust the level of a point on the sample surface via the kinematic mount to which it is coupled.

12. The system of any of claims 6 to 11 wherein the plate is a sample vessel.

13. The system of any preceding claim wherein the leveller is configured to adjust the level of the first, second and third points on the levelling surface in a first and second direction.

14. The system of claim 13 wherein the first and second directions oppose one another, extending from the sample surface.

15. The system of any preceding claim wherein the first, second and third points are closer to a periphery of the surface than a central point of the surface.

16. The system of any preceding claim wherein the leveller is configured to adjust the level of the first, second and third points in increments between 10 and 80 nanometres.

17. The system of any preceding claim further comprising an imaging means.

18. The system of claim 17 wherein the reference plane is a focal plane of the imaging means.

19. The system of claim 17 wherein the imaging means is a microscope having a resolution of less than 10 micrometres in its z direction.

20. The system of claim 17 wherein the imaging means is configured to image single molecules.

21. The system of any preceding claim wherein the leveller is configured to adjust the level of the first, second and third points sequentially.

22. A nanometre scale levelling method for a sample surface for imaging samples comprising single molecules on a nanometre scale, the method comprising:
adjusting a level of a first, second and third point on a sample surface relative to a reference plane, the sample surface being configured to hold samples comprising single molecules for imaging, until the first, second and third points are level with the reference plane on a nanometre scale.

23. A computer program for executing the method of claim 22.

24. A non-transitory computer-readable medium on which are encoded instructions for carrying out the method of claim 22.

25. A computer-readable medium on which are encoded instructions for carrying out the method of claim 22.
